(19) United States
(12) Patent Application Publication
(10) Pub. No.: US 2007/0192438 A1
(43) Pub. Date: Aug. 16, 2007

(54) System and method for on-demand delivery of media products

(76) Inventor: Esmond Goei, Erie, CO (US)

Correspondence Address: HOWISON & ARNOTT, L.L.P, P.O. BOX 741715, DALLAS, TX, 75374-1715, US

(21) Appl. No.: 11/352,929

(22) Filed: Feb. 10, 2006

(51) Int. Cl. G06F 15/16

(52) U.S. Cl. 709/219

(57) ABSTRACT

A system and method of providing media on demand to a mobile device user having a wireless enabled mobile device is disclosed. The method includes identifying the mobile device user at a first retail location, providing a first set of media purchase options to the wireless enabled mobile device, receiving a first selection from the mobile device responsive to the first set of media purchase options, preparing a media product responsive to the first selection, and providing the media product at a predetermined pickup location for pickup by the mobile device user.

### CROSS-REFERENCE TO RELATED APPLICATIONS

This application is related to, and being filed concurrently with, U.S. patent application Ser. No. ______ entitled METHOD OF DELIVERING COUPONS USING CUSTOMER DATA (Attorney Docket No. CYPH-27,544), and U.S. patent application Ser. No. ______ entitled SYSTEM AND ARCHITECTURE FOR PROVIDING RETAIL BUYING OPTIONS TO CONSUMER USING CUSTOMER DATA (Attorney Docket No. CYPH-27,545), which are hereby incorporated by reference.

### TECHNICAL FIELD OF THE INVENTION

This invention is related to media product delivery in general, and more specifically, to on-demand media product delivery.

### BACKGROUND OF THE INVENTION

Consumers have unique and special needs for selection of viewable and auditory media. Some consumers prefer delivery of media via digital video disk (DVD). Other consumers prefer electronic delivery and therefore are not concerned with the physical format of the media. Finally, there are those consumers that still prefer analog formats such as VHS. Similarly, for delivery of audio media, a vast array of delivery choices exists. Consumers may choose from compact disc (CD) media, audio DVD, mp3, and other electronic delivery formats. Traditional analog media formats, such as cassette tape, are also available. Conditioned to the wide array of choices regarding the means of the delivering media, consumers also have wide ranging preferences regarding the time of delivery of their media. For example, some consumers prefer to plan purchases in advance, and, thus, will either shop online or shop at a traditional brick-and-mortar media outlet. However, other consumers prefer a more spur-of-the-moment media buying experience and thus may become motivated to purchase media products in more non-traditional outlets, such as grocery stores and/or convenience stores.

Due to the wide range of choices and preferences of consumers, retailers face a wide array of problems regarding the format and timing of delivery of media products. Traditional movie rental and audio media formats have become expensive to maintain in vast physical quantities to cater to varying needs of consumers. A retailer may be forced to decide to only stock more popular titles and formats of media and therefore be unable to serve the entire consumer base. As consumer preferences for titles and media formats change, the retailer is also forced to adjust inventory or risk losing customers or sales. Finally, the retailer faces the issue of which titles and formats to display, taking into account the limited amount of time that most consumers are willing to spend in order to make a selection.

Therefore, what is needed is a system and method to address the above and related issues.

### SUMMARY OF THE INVENTION

The present invention disclosed and claimed herein, in one aspect thereof, comprises a method of providing media on demand to a mobile device user having a wireless enabled mobile device. The method includes identifying the mobile device user at a first retail location, providing a first set of media purchase options to the wireless enabled mobile device, receiving a first selection from the mobile device responsive to the first set of media purchase options, preparing a media product responsive to the first selection, and providing the media product at a predetermined pickup location for pickup by the mobile device user.

The present invention disclosed and claimed herein, in another aspect thereof, comprises a system for providing media on demand to a customer having a wireless enabled mobile device. The system includes a first wireless access point configured to identify a first customer in proximity thereto by a unique customer identifier submitted to the first wireless access point by the wireless enabled mobile device, an application server configured to provide a plurality of media purchase offers based on a customer profile associated with the first customer identifier, and a media server configured to prepare at least one copy of a media title in response to an acceptance by the customer communicated through the wireless enabled mobile device of one of the plurality of media offers.

The present invention disclosed and claimed herein, in another aspect thereof, comprises a method of providing motion picture media to a customer having a wireless enabled handheld device. The method includes providing an application to the customer for execution on the handheld device, the application operable to provide a unique customer identifier for the customer, determining when the customer is proximate a retail location by receiving the unique customer identifier transmitted from the wireless enabled device, retrieving a customer profile associated with the customer based on the unique identifier, providing a series of choices for motion picture media to the customer via the wireless enabled device, receiving a customer choice responsive to the choices of motion picture media and transmitted by the wireless enabled device, encoding a digital video disc (DVD) to contain a motion picture identified by the customer choice.

### BRIEF DESCRIPTION OF THE DRAWINGS

For a more complete understanding of the present invention and the advantages thereof, reference is now made to the following description and the accompanying Drawings, in which:

FIG. 1 is a functional block diagram of one embodiment of a system for on-demand media delivery;

FIG. 2 is a functional block diagram illustrating one possible environment for operation of the on-demand media delivery system of FIG. 1;

FIG. 3A is an illustration of a wireless enabled device displaying a menu associated with the on-demand media delivery system of FIG. 1;

FIG. 3B is an illustration of a wireless enable device displaying a bar code provided by the on-demand media delivery system of FIG. 1;

FIG. 4 is a flow diagram illustration one possible method of operation of the on-demand media delivery system of FIG. 1; and

FIG. 5 illustrates a flow chart depicting the operation of the application server and its interface with the mobile device;

FIG. 6 illustrates a block diagram of the media server;

FIG. 7 illustrates an illustrative embodiment of a typical media embodied with a Flash Drive; and

FIG. 8 illustrates a flow chart for the operation of the media burner.

### DETAILED DESCRIPTION OF THE INVENTION

Referring now to the Drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

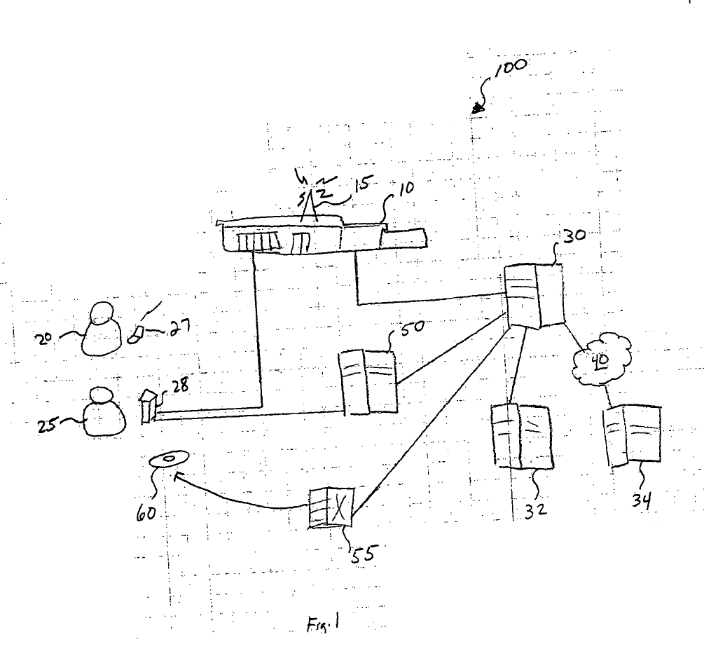

Referring now to FIG. 1, a functional block diagram of one embodiment of an on-demand media delivery system 100 is illustrated. A retail location 10 provides one option for a base of operations for the on-demand media delivery system 100. The retail location 10 provides a wireless access point 15, which may be used to interact wirelessly with a customer 20 via a wireless enabled device 27. In some embodiments, a customer 25 may also have the option of interacting with the system 100 via a kiosk 28. Although FIG. 1 shows only two customers, it is understood that the system 100 may be capable of serving many customers simultaneously. The system 100 provides an application server 30 that provides at least part of the control and functionality of the system 100. The application server 30 may be connected to an affinity server 32 which provides detailed customer information, i.e., a customer profile. The detailed customer information may be used as herein described to create customized purchase offers for the customers 20, 25. In some embodiments, the application server 30 will connect to one or more affinity servers, such as affinity server 34 via the Internet 40 or any network interface. The application server 30 may also interface to a separate payment processing system 50 that is configured to provide payment processing services for media purchased via the on-demand media delivery system 100. The application server 30 may also interface to a separate media server 55. The media server 55 may provide the actual media preparation for the on-demand media delivery system 100 and provide delivery of the physical media product 60.

The retail location 10 may be a dedicated media outlet, such as a traditional record store or video rental establishment. In other embodiments of the on-demand media delivery system 100, the retail location 10 may be a department store or a non-traditional media outlet store, such as supermarket, gas station, hardware store, or other location. The wireless access point 15 may be provided in or around the retail location 10. The wireless access point 15 may be an antenna or a transmitter providing a wireless phone or data signal, a Wi-Fi network, a Wi-Max network, a UMA network, a portion of a satellite network, a Bluetooth® network, or other wireless network. The present disclosure is not meant to be limited to the technologies listed herein for the wireless access point 15. The wireless access point 15 may be any wireless device or system capable of interacting with a wireless enabled device 27.

The wireless enabled device 27, which may be carried by customer 20, may be any device capable of sending data to and receiving data from the wireless access point 15. For example the wireless enabled device 27 may be a mobile phone, a personal digital assistant (PDA), a hand-held computer, a laptop, a text messaging device, or other electronic device capable of remote wireless communication. In one embodiment, the retail location 10 may provide identification software or location aware software for operation on the device 27. Customers may install the software on the device and in some instances it may be downloaded from the application server 30 on an as needed basis. The software on the device 27 may automatically register with the system 100 when the customer 20 is within close proximity to the retail location 10. The software may provide an identification of the customer 20 that may be used by the system 100 to associate the customer 20 to a previous purchase history, affinity group, or other information. The software residing on the mobile device 27 may also be adapted to provide a series of interactive menus to the customer 20 as provided by the application server 30. The menus provided may be personalized based on stored customer preferences associated with their profile in the affinity server. In some embodiments, the menu may provide choices such as viewing preview segments of audio, video, or other media being offered to the customer 20. The format of any preview content is created appropriately for delivery and replay on the wireless enabled device 27 being used by the customer 20. Account band-width, display, and audio capabilities of the devices, and other limitations may be considered. Via the wireless enabled device 27, the customer 20 is able to make selections and purchases of the media content offered by the systems 100. The kiosk 28 may provide similar functionality as the software residing on the wireless enabled device 27, thus allowing customer 25 to interact with and purchase from the on-demand media delivery system 100 as if the customer 25 also operated a wireless enabled device such as wireless enabled device 27.

The application server 30 provides the control and functionality of the system 100. The application server 30 may be a commercially-available, off-the-shelf personal computer or other computing device. The application server 30 may be a Windows®-based computer, a Unix®-based computer, or a Java® virtual machine. The application server 30 interacts with the wireless enabled device 27 via the wireless access point 15 and also with the kiosk 28 through direct wiring. The application server 30 may be physically located within the retail location 10 or it may be located offsite. The application server 30 provides media purchase options to customers 20, 25 as previously described. In some embodiments, the application server 30 may store electronic copies of the media being offered for purchase to customers 20, 25. The application server 30 may also contain one or more relational databases for associating the unique identification of the customers 20, 25 with purchase histories and other personalized information.

In providing menu options and media purchase offers to customers 20, 25, the application server 30 may first operate to determine which offers are most likely of interest to a particular customer 20, 25. Thus, the options presented to each customer 20, will be personalized based on information contained within the application server 30. The choices offered to the customers 20, 25 could be based on information such as where the customer 20, 25 has shopped before, what the customer 20, 25 has purchased in the past, analysis of buying patterns that are suggestive that certain media titles would be desired for purchased, or other algorithmic determinations of what a customer may wish to purchase.

In additional to utilizing information stored within the application server 30, the application server 30 may interact with one or more affinity servers 32, 34 to make a determination as to which offers to provide to customers 20, 25. The application server 30 may contain a relational database associating the unique identification of the customers 20, 25 with that customer's unique identification key on one or more affinity servers 32, 34. In some embodiments, the application server 30 may be interfaced through a private network to the affinity server 32, and in other embodiments, the application server 30 may interface with one more affinity servers, such as affinity server 34 through the Internet or other wide-area network 40. Once the application server 30 has identified a customer 20, 25 to the affinity server 32, 34, the affinity server 32, 34 may provide additional detailed customer information back to the application server 30. The application server 30 may then take the additional information into account when determining which media purchase options to provide to customers 20, 25. The affinity servers 32, 34 may be additional data repositories containing additional customer information which may be owned or used by third parties. Examples of third parties who may use or provide affinity servers 32, 34 include, but are not limited to, mail order and internet retailers, brick-and-mortar retailers, airlines, hotels, travel clubs, car rental programs, warehouse purchase clubs and other entities with which customers 20, 25 may interact. Customers 20, 25 may consent to sharing of information between affinity servers 32, 34 and application server 30 by explicit agreement or by previous customer agreements with third parties owning or operating affinity servers 32, 34. In some instances, customers 20, 25 are willing to give permission for information sharing in order to minimize the number of offers presented by the application server 30 and others in which the customer 20, 25 has little or no interest.

If the customer 20, 25 makes a decision to purchase, the decision may be communicated to the application server 30 via the hand-held device 27 and/or the kiosk 28. Arrangements for payment may then be made. In some cases, payment information may be collected by the application server 30 and forwarded to a payment processing system 50. The payment processing system 50 may be a credit card service, a bank, or other payment processing service. The payment processing service 50 may provide confirmation to the application server 30 that the customer 20, 25 has sufficient funds to cover the purchase of the media. In some embodiments, the customer 20, 25 may pay for the media purchase at a time subsequent to making the selection of the media, such as when leaving or checking out of the retail location 10. Thus, the customer 20, 25 may be able to include the payment for the media purchase with a transaction that may include payment for other items purchase at the retail location 10. In one embodiment of the on-demand media delivery system 100, the application server 20 may provide a barcode or other identification means to the mobile device 27 of the customer 20 that may be used to identify the media purchase transaction. If a customer, such as the customer 25, is engaging the transaction via the kiosk 28, the kiosk may provide a printed bar code. When the customer 20 proceeds to checkout or leave the retail location 10, the customer 20 may selectively display the barcode corresponding to the media purchase, thus identifying both the media purchased, the priced offered, and other information relating the transaction.

To fulfill the customer 20 request for purchase of a media product 60, the application server 30 may forward the request to the media server 55. The media server 55 may serve as an electronic repository of media products available for sale. Such media products include, but are not limited to, movies, television programs, music titles, audio books, radio programs, and other audio visual content that a customer 20, 25 may wish to purchase. The media server 55 operates to prepare the physical medium upon which such media content may be applied or stored. The physical media may include, but is not limited to, DVDs, CDs, or other optical storage media, solid state memory media, such as compact flash, secure digital, multi-media card, or other solid-state memory. The prepared portable medium 60 may be labeled physically or electronically with content, title, customer name, or other identifying information. The media server 55 may also provide digital rights management (DRM) for media purchased through the on-demand media delivery system 100. In some instances customers 20, 25 may purchase unlimited use media content, but in other cases, a customer 20, 25 may choose a limited number of viewings or playing of the medium 60. The pricing for the purchased content would reflect either limited replaying capabilities or unlimited replaying.

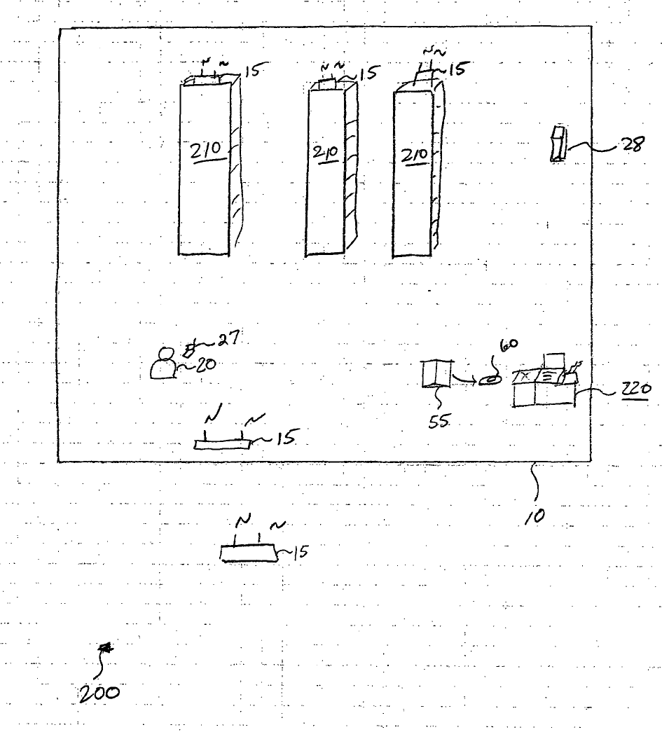

Referring now to FIG. 2, a functional block diagram, illustrating one possible environment 200 for the operation of the on-demand media delivery system 100 of FIG. 1 is shown. As can be seen in FIG. 2, retail location 10 may include one or more separate merchandise locations 210. The merchandise locations 210 may correspond to different shelving areas within the retail location 10, different departments within the retail location 10, or any other areas within the retail location 10 wherein it may be desirable to have a location provided for the customer 20 based on the location of the wireless enabled device 27. It can also be seen from FIG. 2, that multiple wireless access points 15 may be provided at various locations inside and outside the retail location 10. In this way, it may be possible to track, on a real-time basis, the location of the customer 20 within the various areas of the retail location 10. As previously described, this information may be used to custom-tailor presentation of menus and options available for the customer based in part of the type of goods within the retail location 10 that the customer 20 is viewing or views most often. One or more kiosks 28 may also be provided at various strategic locations inside or outside the retail location 10. As described, the kiosks 28 may replicate the functionality provided by the software on the wireless enabled device 27, thus enabling customers not operating a wireless enabled device, such as wireless enabled device 27, to access the on-demand media delivery system 100 as described herein. The application server 30 of FIG. 1 may or may not be provided in the same physical location as the retail location 10. In such case, a separate media server 55 will be provided in the retail location 10. As described, the media server 55 actually prepares and delivers the physical medium 60 for purchase by the customer 20. Following a media purchase by the customer 20, a barcode may be provided that may be displayed on their wireless enabled device 27 at a checkout or transaction register 220. If using a kiosk 28, a printed barcode may be provided by the kiosk 28, or the transaction may be linked to another means of identifying the customer, such as a store club card. In this manner, the purchase transaction, the customer, and the physical media 60 may be identified at the transaction register 220. The customer 20 may wish to provide payment for the media purchased at the transaction register 220 or may have made separate payment arrangements using the wireless enabled device 27 and/or the kiosk 28.

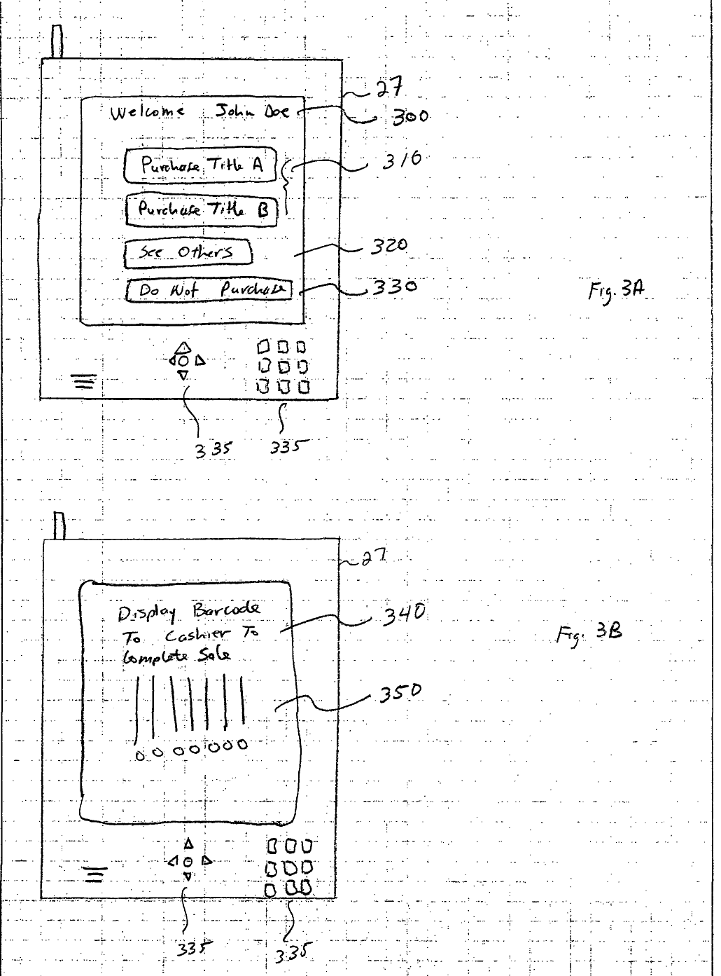

Referring now to FIG. 3A, an illustration of a wireless enabled device 27 displaying a menu associated with the on-demand media delivery system of FIG. 1 is shown. A greeting 300 and/or other background information may be provided. As described, the wireless device 27 displays menus 310 with options for purchase of media products displayed thereon. In addition to being able to select titles for purchase, a customer may also have the option 320 of viewing additional titles or of choosing not to view more offers 330. In addition to the options shown, the handheld device 27 may also provide the ability for the customer to update a profile with the application server 130 (FIG. 1) or set preferences, etc. The customer may also use the wireless enabled device 27 to select a preferred media delivery format. The customer may elect such options as DVDs, CDs, delivery on a flash memory, or immediate electronic delivery.

Referring now to FIG. 3B an illustration of a wireless enabled device 27 displaying a bar code 350 provided by the on-demand media delivery system 100 of FIG. 1. In the event that a customer chooses to make a media purchase through the on-demand media delivery system 100, the on-demand media delivery system 100 may provide a barcode 350 to the wireless enabled device 27. The barcode 350 may be used to track the transaction and may be used by the system 100 to track the media sale event. The barcode may be used by the application server 30 (FIG. 1) to associate the physical media 60 (FIG. 1) with the purchase transaction and to identify the customer when he or she arrives to pickup and/or pay for the medium 60. Depending upon the software provided by the on-demand media delivery system 100 for use on the wireless enabled device 27 and/or the functionality of the wireless enabled device 27, the customer may selectively display the barcode in order to allow the device 27 to be used for other purposes while the customer is at the retail location 10. Also shown in FIG. 3B is a prompt 340 for informing the customer of the next step in the transaction. Thus, a first time or infrequent user of the on-demand media delivery system 100 may be provided real time help or guidance on how to complete the transaction. Moreover, since the on-demand media delivery system 100 may be configured to operate with a wide array of wireless enabled devices 100, the user may be able to have multiple devices, each capable of operating with the on-demand media delivery system 100.

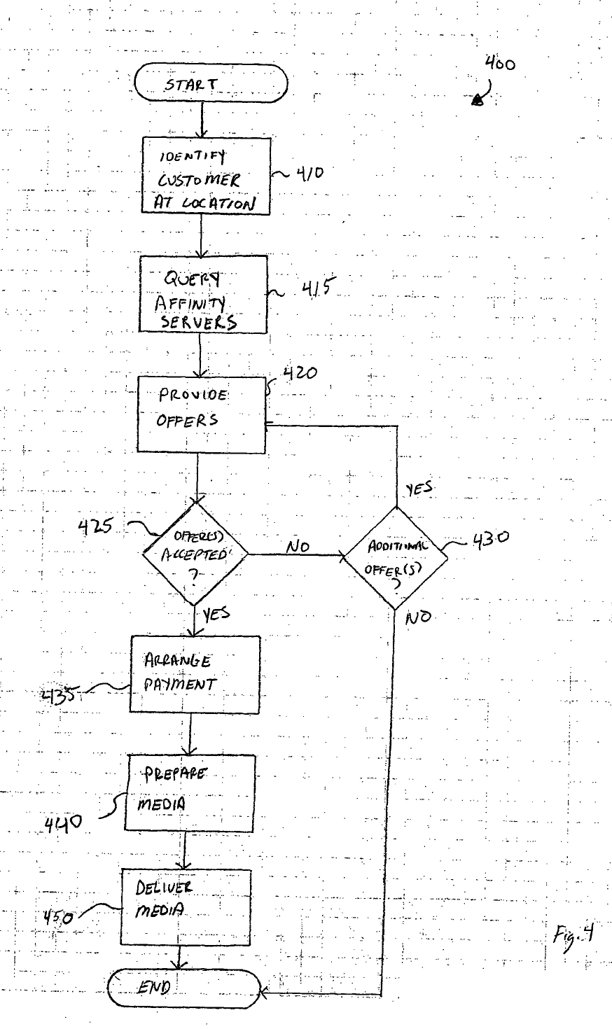

Referring now to FIG. 4, a flow diagram 400 illustrating one possible method of operation of the on-demand media delivery system 100 shown in FIGS. 1 and 2 is illustrated. A customer may be identified by the on-demand media delivery system at step 410. The customer may be identified at a retail location generally, or at a specific location near or in the retail location, such as locations 210 shown in FIG. 2. The customer may be identified by software present on a wireless enabled device or by scanning or presenting an identification number.

When a customer has been identified by the on-demand media delivery system, the on-demand media delivery system may query additional affinity servers at step 415. The affinity servers may provide detailed customer information and preferences as previously described. Using this and other information, offers may be provided at step 420. Offers may include options of purchasing movies, televisions programs, songs, radio broadcasts and the like as previously described. The offers may be provided via a wireless enabled device belonging to the customers through a series of interactive menus displaying various media and purchase options. Using the wireless enabled device, the customer may either accept or decline any of the offers presented at step 425. In some embodiments, if the customer declines offers at step 425, the system may have additional offers to present the customer at step 430. If so, the additional offers are provided at step 420.

In the event a customer accepts an offer at step 425, arrangements for payment may be made at step 435. As stated, in some embodiments, payments may be arranged via the wireless enabled device and/or the kiosk. In other embodiments, the customer may wish to complete payment when other purchases are also made, for example, upon leaving the retail location. At step 440 the media is prepared. This may include burning a DVD or CD, writing files to a non-volatile memory, or preparing an electronic file for distribution directly to a customer via the wireless enabled handheld device. At step 450, the media is actually delivered which may include providing the customer with physical media that has been prepared at step 440 or uploading the electronic purchase into memory of a device that may be provided by the customer.

Referring now to FIG. 5, there is illustrated a flow chart for the operation of the application server. The flow chart is initiated at a block 502 and then proceeds to a decision block 504 in order to determine if the mobile device is within range. Once the mobile device has been detected, the program flows along “Y” path to a function block 506. The mobile device, as described hereinabove, can be any type of mobile device. It is only important that once it comes within a “zone,” that it is recognized. Recognition may be via a handshake, via a simple wireless connection such as an 802.11 communication link, or via a protocol associated with the “Bluetooth” communication devices. Of course, there are other communication protocols, such as Zigby, etc., that could be utilized. It is only important that there is some way to determine that a mobile device is in proximity to the media burning kiosk or facility. Further it could be a combination of devices wherein some type of passive RFID device was utilized to recognize proximity, and then a connection made via some other type of wireless device such as a cell phone.

Once the mobile device has been detected, the function block 506 will request from the mobile device at least a user ID and possibly a physical ID. The user ID will definitively identify the user to the system and the affinity server. The physical ID may be used to identify a particular device. When the user creates their profile in the affinity server, they may associate with that user ID various physical devices and their physical IDs. In this manner, the system can recognize different types of devices and, therefore, customize the type of output that is provided to that device. There may be some devices that will only receive voice commands and others that have displays associated therewith. These displays can be various and sundry displays. For example, a conventional PDA has a very small whereas a PC has a larger display and could provide for the receipt of more information. Once the user ID and physical ID are received, the program flows to a decision block 508 to determine if the user is authorized. If not, the program flows to a block 510 to reject the mobile device. Once authorized, the program will flow to a function block 510 to assemble a focused selection for the user and then transmit this to the user as indicated by function block 512 in order to provide a display to the user. The system will then wait for a selection to be a made by the user, as indicated by a decision block 514. If no selection is made, this may indicate that the user does not desire any of the selections. There may be a time-out or an actual rejection by the user. If so, the program will flow along a “N” path to a function block 516 to assemble an alternate selection for presentation to the user. This may be information that is not actually associated with the product sold by the facility, i.e., media that is burned for the user, but may be such things as advertisements that other vendors may want to display to the user. If the alternate selections are selected, as indicated by decision block 518, then the program flows back to the input of a function block 520. However, if the alternate selection presented to the user is not selected, the program will flow along a “N” path to an exit block 522.

If the initial selection presented to the user is selected, as indicated by flow out of the decision block 514 along the “Y” path, the program will flow to the function block 520. Thus, function block 520 will process either the alternate selection or the primary selection. Once the selection is processed, the system will determine if the selection is available and it will return a confirmation to the user, as indicated by a function block 526. The program then flows to a function block 528 to determine if payment is required, i.e., was it preauthorized, was it a promotion, etc. If preauthorized, then no payment is needed and the program will flow along the “N” path. However, if payment is required, the program will flow along the “Y” path to a function block 530 to process the payment. This payment can be the input of credit card information to some type of kiosk or even the input of credit card information into a card reader on the PDA. It could be some type of preauthorized payment service, such as the commonly known service, PayPal®, or some such. In any event, a process may be needed to go further to complete the transaction. Thus, either path from the decision block 528 or the process payment of 530 will flow to a function block 534 in order to complete the transaction such that the user is then authorized to obtain the product or the media that is being prepared. The program then flows to an exit block 536.

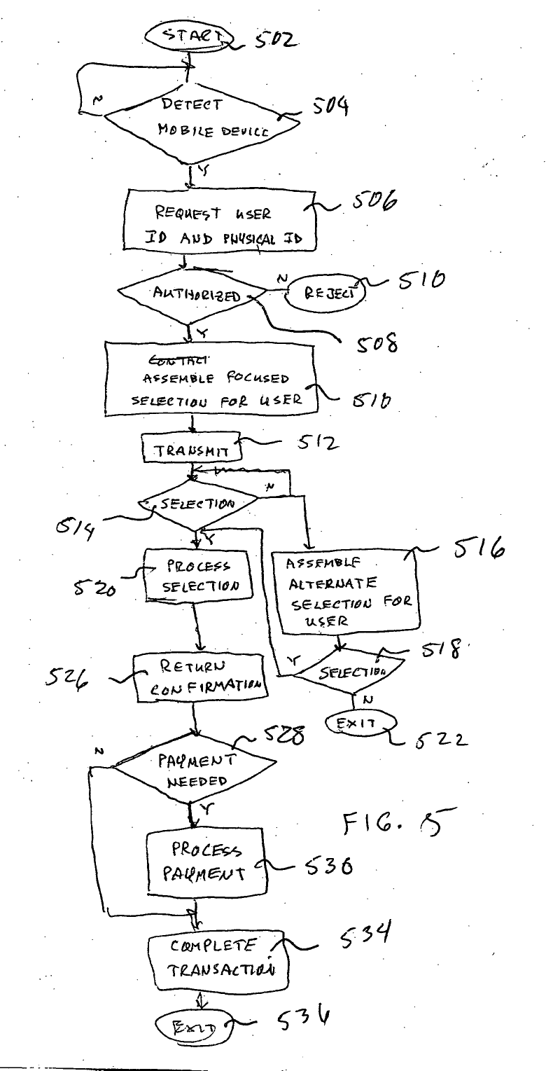

Referring now to FIG. 6, there is illustrated a block diagram for the actual media burner system in a kiosk. At the heart of this media-burner system is a control system 602. An input sensor 604 is operable to receive input from the mobile device 27,28. This could be the scanning of a barcode, the input by a teller, etc. In any event, the mobile device provides the input and there is some type of authorization provided via a connection from the mobile device to some input sensor or input system. This provides a control signal to the control system 602 that will authorize a predetermined selection made by a user or one that is associated with a preauthorized barcode or the like. In any event, the control system 602 recognizes that there is some selection that is to be provided to the user that has been previously authorized. This authorized selection then requires a control system to determine what selection is authorized and what selection is to be provided to the user. This is to be burned onto a media 606. The media could be any type of media. In this example, a USB-based Flash Drive will be embodied; however, this could be a pocket drive, a CD, or a DVD.

When the control system 602 processes a selection, it must determine whether the selection is stored locally. If electronic, it will have to go a local server 610 to determine if the data is there that can be burned onto a particular media. Of course, this local storage could be pre-recorded media. If it is data, the data must in local server 610 in order to burn it on the media locally. However, if it is not on the local server, then the control system 602 has the ability to go through a communications device 612 to a remote server 614 at a remote location. This could be a satellite link or it could be a fiber optic link to a central server base. In any event, an entire program, such as a movie, could be down-loaded from a remote server 614 for storage in the local server 610. This could be a cached system such that older movies that have not been selected in a certain amount of time would be deleted. This would minimize the amount of storage that was associated with the control system 602 on a local basis.

Once the control system 602 recognizes that the appropriate selection is stored in the local server 610, either previously or recently from the remote server 614, then the media 606 is burned through a media creator 618. This media creator is nothing more than a device that can write to the media.

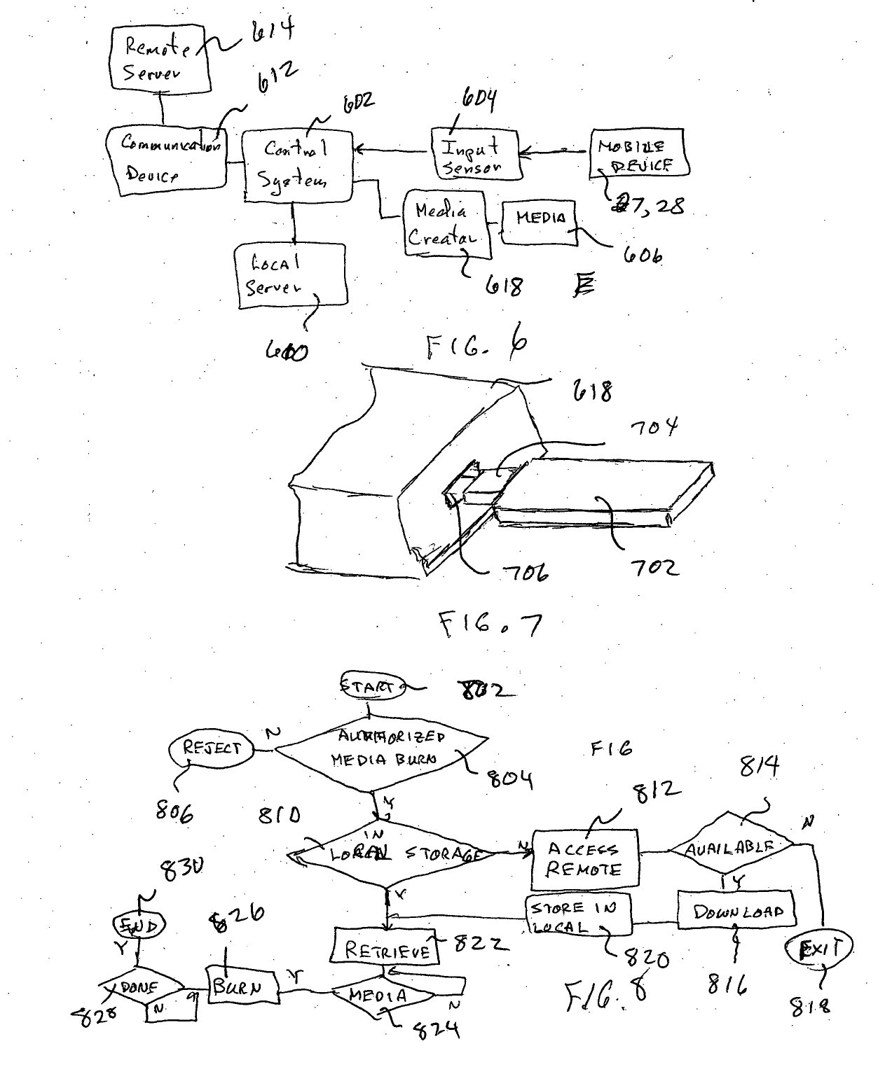

Referring now to FIG. 7, there is illustrated an illustration of an exemplary media creator 618. This a drive socket for a USB Flash Drive 702. This Flash Drive 702 has a USB connector 704 that can be inserted into a receptacle 706 to the media creator 618. The USB drive, as is well known, is a powered drive such that power is supplied to the USB connector to the flash drive 702. The flash drive 702 has a sufficient amount of storage to store the program thereon. This media 618 has the ability to detect the presence of the USB device. This is conventional, as all USB devices have the interface software associated therewith to allow recognition thereof and, more specifically, the recognition of exactly what type of device is inserted therein.

Referring now to FIG. 8, there is illustrated a flow chart depicting the operation of the media burner. This is initiated at a start block 802 and then proceeds to a decision block 804 to determine if there is authorization to burn this media. If not, the program flows to a Reject block 806, and, if so, the program flows along “Y” path to a decision block 810 to determine if the program selected is in local storage. If not, the program flows along a “N” path to a function block 812 to access the remote server 614 to obtain the program. The program then flows to a decision block 814 to determine if the selected program is available at the remote server. If so, the program flows along a “Y” path to a function block 816 to download the program, and, if not, it flows along a “N” path an exit block 818. Once downloaded, the program will store the program in the local server 610, as indicated by a function block 820. The program then flows to a function block 822. The function block 822 is also the destination of the decision block 810, when it is determined that the local server 610 contains a program, at which time, the program will flow from the decision block 810 along the “Y” path the function block 822 to retrieve the data from the local server 610. The program then flows to a decision block 824 to await insertion of the media 606 into the media creator 618. Once this occurs, the program flows along a “Y” path to a function block 826 to burn the media and then to a decision block 828 to determine if the burn is complete. At that point, the program flows to an end block 830.

It will be appreciated by those skilled in the art having the benefit of this disclosure that this invention provides a broadband information appliance. It should be understood that Drawings and detailed description herein are to be regarded in an illustrative rather than a restrictive manner, and are not intended to limit the invention to the particular forms and examples disclosed. On The contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed it:

1. A method of providing media on demand to a mobile device user having a wireless enabled mobile device, comprising:
identifying the mobile device user at a first retail location;
providing a first set of media purchase options to the wireless enabled mobile device;
receiving a first selection from the mobile device responsive to the first set of media purchase options;
preparing a media product responsive to the first selection; and
providing the media product at a predetermined pickup location for pickup by the mobile device user.

2. The method of claim 1, further comprising:
receiving payment information from the mobile device corresponding to the first selection; and
providing the payment information to a third party for processing.

3. The method of claim 1, further comprising:
querying an affinity server based on a unique identifier associated with the mobile device user; and
receiving customer data associated with the mobile device user from the affinity server responsive to the query;
wherein providing a first set of media purchase options comprises providing a first set of media purchase options to the wireless enabled mobile device responsive to the customer data.

4. The method of claim 1, further comprising:
providing a second set of media purchase options to the wireless enabled mobile device; and
receiving a second selection from the mobile device responsive to the second set of media purchase options.

5. The method of claim 1, wherein preparing a media product responsive to the first selection comprises preparing a digital video disc (DVD) product.

6. The method of claim 1, wherein providing a first set of media purchase options to the wireless enabled mobile device comprises providing a first set of media purchase options to the wireless enabled mobile device responsive to the first retail location.

7. The method of claim 1, further comprising:
identifying the mobile device user at a second retail location;
providing a second set of media purchase options to the wireless enabled mobile device; and
receiving a second selection from the mobile device responsive to the second set of media purchase options.

8. The method of claim 1, wherein the first set of media purchase options comprises a lists of digital video disc (DVD) titles available for purchase.

9. The method of claim 1, wherein identifying the mobile device user at a first retail location comprises determining that the mobile device user is near a predetermined location within a retail store.

10. The method of claim 1, further comprising scanning a barcode displayed on the mobile device to identify the prepared media product at the predetermined pickup location.

11. A system for providing media on demand to a customer having a wireless enabled mobile device, comprising:
a first wireless access point configured to identify a first customer in proximity thereto by a unique customer identifier submitted to the first wireless access point by the wireless enabled mobile device;
an application server configured to provide a plurality of media purchase offers based on a customer profile associated with the first customer identifier; and
a media server configured to prepare at least one copy of a media title in response to an acceptance by the customer communicated through the wireless enabled mobile device of one of the plurality of media offers.

12. The system of claim 11, further comprising a transaction register configured to scan a barcode displayed on the wireless enabled mobile device, the barcode providing an identification of the at least one media product prepared in response to the acceptance by the customer.

13. The system of claim 11, further comprising a kiosk configured to receive the unique customer identifier from the customer, provide the plurality of media purchase offers to the customer, and receive the acceptance from the customer.

14. The system of claim 11, further comprising a second wireless access point configured to identify the first customer in proximity thereto by the unique customer identifier submitted to the second wireless access point, the unique customer identifier being submitted by the wireless enabled mobile device;
wherein the application server is configured to provide the plurality of media purchase offers responsive to the customer profile and the customer's proximity to the first or second wireless access point.

15. The system of claim 14, further comprising an internet connection for querying an affinity server to retrieve customer affinity data;
wherein the application server is configured to provide the plurality of media purchase offers responsive to the customer profile, the customer's proximity to the first or second wireless access point, and the customer affinity data.

16. The system of claim 15, further comprising a relational database associating the unique customer identifier with a second unique identifier used by the affinity server to identify the customer.

17. A method of providing motion picture media to a customer having a wireless enabled handheld device comprising:
providing an application to the customer for execution on the handheld device, the application operable to provide a unique customer identifier for the customer;
determining when the customer is proximate a retail location by receiving the unique customer identifier transmitted from the wireless enable device;
retrieving a customer profile associated with the customer based on the unique identifier;
providing a series of choices for motion picture media to the customer via the wireless enabled device;
receiving a customer choice responsive to the choices of motion picture media and transmitted by the wireless enabled device; and
encoding a digital video disc (DVD) to contain a motion picture identified by the customer choice.

18. The method of claim 17, further comprising:
transmitting a barcode to the wireless enabled device, the barcode being associated with the prepared DVD and a price of the DVD; and
scanning the barcode from the wireless enabled device at checkout register to identify the DVD and the price.

19. The method of claim 17, further comprising:
querying an affinity server to obtain customer affinity data; and
providing the series of choices for motion picture media to the customer via the wireless enabled device based in part on the customer affinity data.

20. The method of claim 17, further comprising providing digital rights management on the encoded DVD.
